(19) United States
(12) Patent Application Publication
(10) Pub. No.: US 2008/0100602 A1
(43) Pub. Date: May 1, 2008

(54) LIQUID-CRYSTAL DISPLAY APPARATUS AND LINE DRIVER

(75) Inventors: Tooru Arai, Fujisawa-shi (JP); Akira Masuko, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/924,202

(22) Filed: Oct. 25, 2007

(30) Foreign Application Priority Data
Oct. 27, 2006 (JP) 2006-292849

(51) Int. Cl. G09G 5/00; G09G 3/36

(52) U.S. Cl. 345/205; 345/87

(57) ABSTRACT

A liquid-crystal display apparatus includes: a liquid-crystal panel that includes pixels that are arranged at positions where a plurality of row selection lines and a plurality of line selection lines intersect, the pixels being driven by activating thin-film transistors connected to the row selection lines and the line selection lines; a row driver that generates a voltage based on gradation data and applies the voltage to the row selection lines by inverting a polarity of the voltage every “n” sets of the row selection lines; and a line driver that drives every “m” sets of the line selection lines in one of a first drive order and a second drive order, wherein the line driver repeatedly performs an operation including: driving the line selection lines in the first drive order for “k” flames; and driving the line selection lines in the second drive order for “k” flames.

### CROSS-REFERENCE TO RELATED APPLICATIONS

This application is based upon and claims the benefit of priority from Japanese Patent Application No. 2006-292849, filed Oct. 27, 2006, the entire contents of which are incorporated herein by reference.

### BACKGROUND OF THE INVENTION

The present invention relates to an active matrix liquid-crystal display apparatus and a line driver for driving the liquid-crystal display apparatus.

Since a matrix liquid-crystal display apparatus, typified by a liquid-crystal display apparatus, is characterized by a reduced thickness, light weight, low power consumption, and the like, the matrix liquid-display device is widely utilized as a display device for a personal computer, a TV, a game machine, and the like. Among others, an active matrix display device having a switching element, such as a thin-film transistor (TFT), provided on a per-pixel basis involves less crosstalk between adjacent pixels and provided a clear image, and hence developments of higher-resolution, higher image-quality, and larger active matrix display devices are now in progress.

The amount of data to be transferred is more increasing than ever along with an increase in the resolution, image quality or size of the active matrix display device. Since a display cycle is essentially determined from a characteristic of the human eye that views a display device, a method for addressing an increase in the amount of image data by means of speeding up a transfer rate is adopted in many cases. Speed-up of the transfer rate entails an increase in a clock frequency for image data transfer purpose. As a result of an increase in clock frequency, an increase in the amount of electric current consumed by a row driver and a line driver for driving the display device, or a like device; namely, an increase the amount of power consumption, becomes noticeable.

Further, an increase in the size of the display device involves an increase in the capacitance of row signal lines of the liquid-crystal panel; that is, load on the row driver. Driving liquid current with an alternative current (i.e., polarity inversion of liquid crystal) for the purpose of prevention of flickering of a screen entails an increase in power consumption. Since a liquid crystal load is capacitive, consumed electric power is transformed into heat by the row driver. Moreover, an increase in the number of liquid crystal loads and the number of row drivers leads to an increase in power consumption. In the meantime, an increase in the area of the row driver commensurate with an increase in frequency and power consumption is allowed rarely, and, if anything, relative miniaturization of the row driver is expected. Miniaturization of the row driver, and the like, raises a problem of heat dissipation being made more difficult.

In order to avoid deterioration, liquid crystal is alternately driven at positive and negative voltages. Polarity inversion is implemented by a frame inversion technique for inverting the polarity of a row signal supplied to pixels every time a frame is changed. In addition to the frame inversion technique, there are also available a line inversion technique for inverting the polarity of the row signal supplied to the pixels in accordance with a row selection line (or a line selection line) on a liquid-crystal panel and a dot inversion technique for inverting the polarity of a row signal which supplies data signals of opposite polarities to adjacent pixels. Since the dot inversion technique enables provision of an image which is superior in image quality to images provided by the other inversion techniques, the dot inversion technique is often adopted for driving a liquid-crystal panel.

Although the dot inversion technique is known to suppress flickering of the screen, polarity must be inverted on a per-adjacent-pixel basis; namely, the capacitance of the row signal line must be inverted on a per-pixel basis, which raises a problem of heavy power consumption. In order to prevent power consumption, there is disclosed an example including dividing the line signal line (a scan line) into a plurality of blocks by means of a scan sequence control circuit; performing interlaced scanning in the block; performing sequential scanning between the blocks; supplying a signal line drive circuit with a data signal rearranged in conformance to the scan sequence of the line signal by means of a data signal rearrangement supply circuit; and driving a signal line such that the polarity of the data signal is inverted between adjacent line signal lines or adjacent pixels (see; e.g., JP-3516382 p. 12 and FIG. 11). A gradation data voltage (a data signal) actually supplied to the respective pixels becomes lower than a voltage output from the row driver because of a line in the liquid-crystal panel, a resistor of a transistor, and the like, and exhibits a tendency to approach the voltage output from the row driver along with elapse of a time.

However, when interlaced scanning is performed within a block during the course of the gradation data voltage supplied to the respective lines tending to increase, the sequence of arrangement of pixels does not coincide with the sequence of supply of the gradation data. Fluctuations in the gradation data voltage become greater at a space between adjacent pixels, and the fluctuations in the gradation data voltage developed between the pixels remain fixed at a position between frames. For these reasons, there is an increase in the chance of image quality failures, such as discontinuity of brightness and color shift, becoming noticeable. Specifically, for example, there is a problem of pixels with a relatively-low gradation data voltage or pixels with a relatively-high gradation data voltage becoming fixed on a liquid-crystal panel and another problem of a sense of image quality failures being felt as a result of visual identification of a bright area and a dark area.

### SUMMARY OF THE INVENTION

According to an aspect of the present invention, there is provided a liquid-crystal display apparatus including: a liquid-crystal panel that includes pixels that are arranged at positions where a plurality of row selection lines and a plurality of line selection lines intersect, the pixels being driven by activating thin-film transistors connected to the row selection lines and the line selection lines; a row driver that generates a voltage based on gradation data and applies the voltage to the row selection lines by inverting a polarity of the voltage every “n” sets of the row selection lines; and a line driver that drives every “m” sets of the line selection lines in one of a first drive order and a second drive order that are different from an arrangement order of the line selection lines on the liquid-crystal panel, wherein the line driver repeatedly performs an operation including: (1) driving the line selection lines in the first drive order for “k” flames; and (2) driving the line selection lines in the second drive order for “k” flames.

According to another aspect of the present invention, there is provided a line driver for driving a plurality of line selection lines arranged in a liquid-crystal display, the line driver including: a shift register that sequentially selects “p” sets of the line selection lines; and a switching device that selects one from among the “p” sets of the line selection lines to drive every “m” sets of the line selection lines in one of a first drive order and a second drive order that are different from an arrangement order of the line selection lines on the liquid-crystal panel.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically showing the configuration of a liquid-crystal display apparatus of a first embodiment of the present invention;

FIG. 2 is an exemplary block diagram schematically showing the configuration of a line driver used in the liquid-crystal display apparatus of the first embodiment of the present invention;

FIG. 3 is a view schematically showing the configuration of a line driver used in the liquid-crystal display apparatus of the first embodiment of the present invention, wherein FIG. 3A is a block diagram, and FIG. 3B is a connection correlation diagram;

FIG. 4 is a view schematically showing time-versus-arrival condition of a gradation data voltage supplied to a pixel of the liquid-crystal display apparatus of the first embodiment of the present invention;

FIG. 5 is an exemplary timing chart of gradation data being output from the liquid-crystal display apparatus of the first embodiment of the present invention;

FIG. 6A-6D are exemplary schematic diagrams showing the distribution of polarities and levels of output gradation data of the liquid-crystal display apparatus of the first embodiment of the present invention;

FIG. 7 is a view schematically showing the correlation of connection between flip-flops of a line driver used in the liquid-crystal display apparatus and lines;

FIG. 8A-8B are exemplary schematic diagrams showing the distribution of polarities and levels of gradation data output in a liquid-crystal display apparatus of a second embodiment of the present invention;

FIG. 9 is a view schematically showing the correlation of connection between flip-flops and lines of line drivers used in a first modification of the second embodiment of the present invention;

FIG. 10A-10B are exemplary schematic diagrams showing the distribution of polarities and levels of gradation data output in a liquid-crystal display apparatus of the first modification of the second embodiment of the present invention;

FIG. 11 is a view schematically showing the correlation of connection between flip-flops and lines of line drivers used in a second modification of the second embodiment of the present invention;

FIG. 12A-12B are exemplary schematic diagrams showing the distribution of polarities and levels of gradation data output in a liquid-crystal display apparatus of the second modification of the second embodiment of the present invention;

FIG. 13 is a view schematically showing the correlation of connection between flip-flops and lines of line drivers used in a third modification of the second embodiment of the present invention;

FIG. 14A-14B are exemplary schematic diagram showing the distribution of polarities and levels of gradation data output in a liquid-crystal display apparatus of the third modification of the second embodiment of the present invention;

FIG. 15 is a view schematically showing the correlation of connection between flip-flops and lines of line drivers used in a third embodiment of the present invention;

FIG. 16A-16B is an exemplary schematic diagrams showing the distribution of polarities and levels of gradation data output in a liquid-crystal display apparatus of the third embodiment of the present invention;

FIG. 17 is an exemplary block diagram schematically showing the configuration of a line driver used in a liquid-crystal device of a fourth embodiment of the present invention; and

FIG. 18 is an exemplary timing chart along which gradation data are written in the liquid-crystal display apparatus of the fourth embodiment of the present invention.

### DETAILED DESCRIPTION OF THE PREFERRED EMBODIMENTS

Embodiments of the present invention will be described hereunder by reference to the drawings. Throughout the drawings, like structural elements are assigned like reference numerals.

### First Embodiment

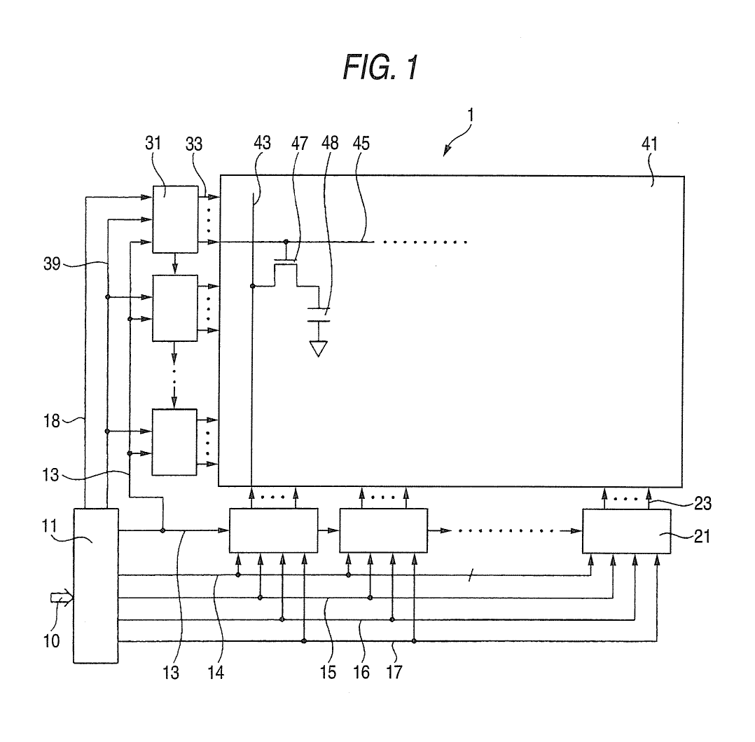

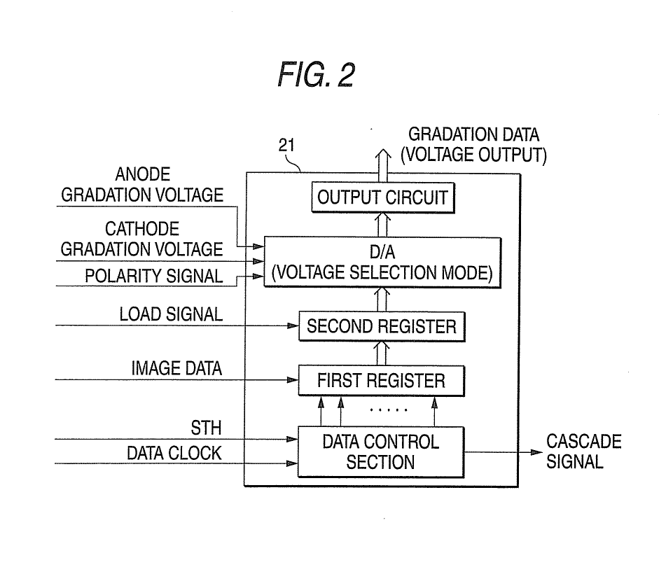

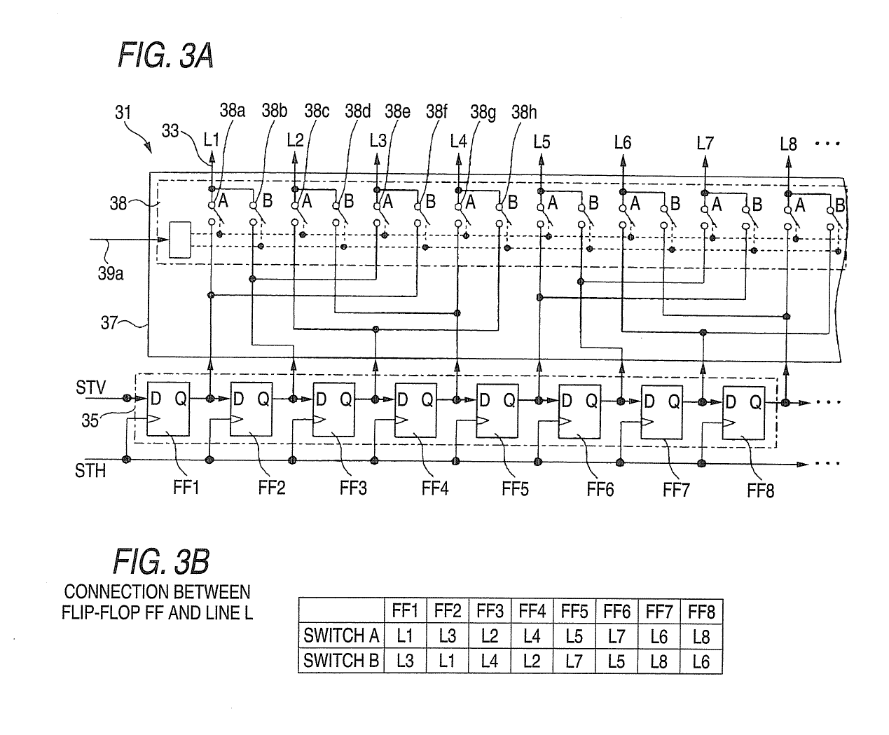

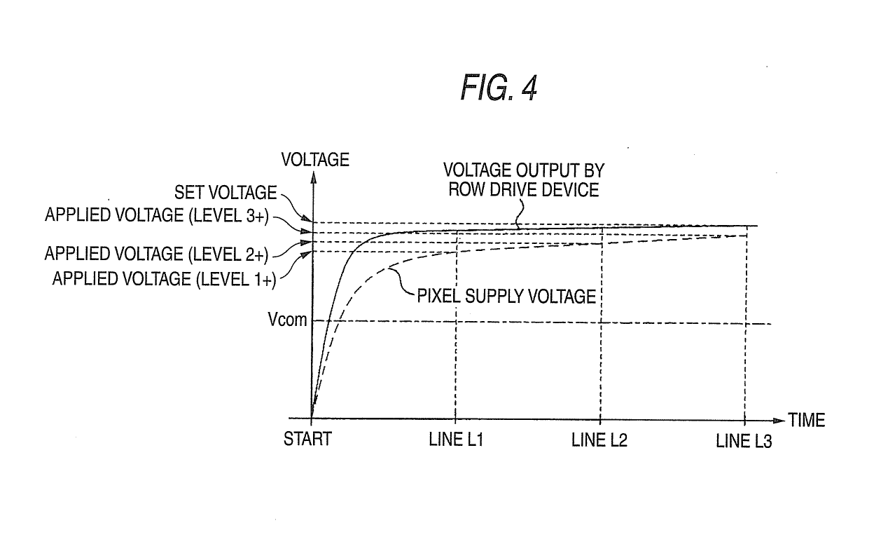

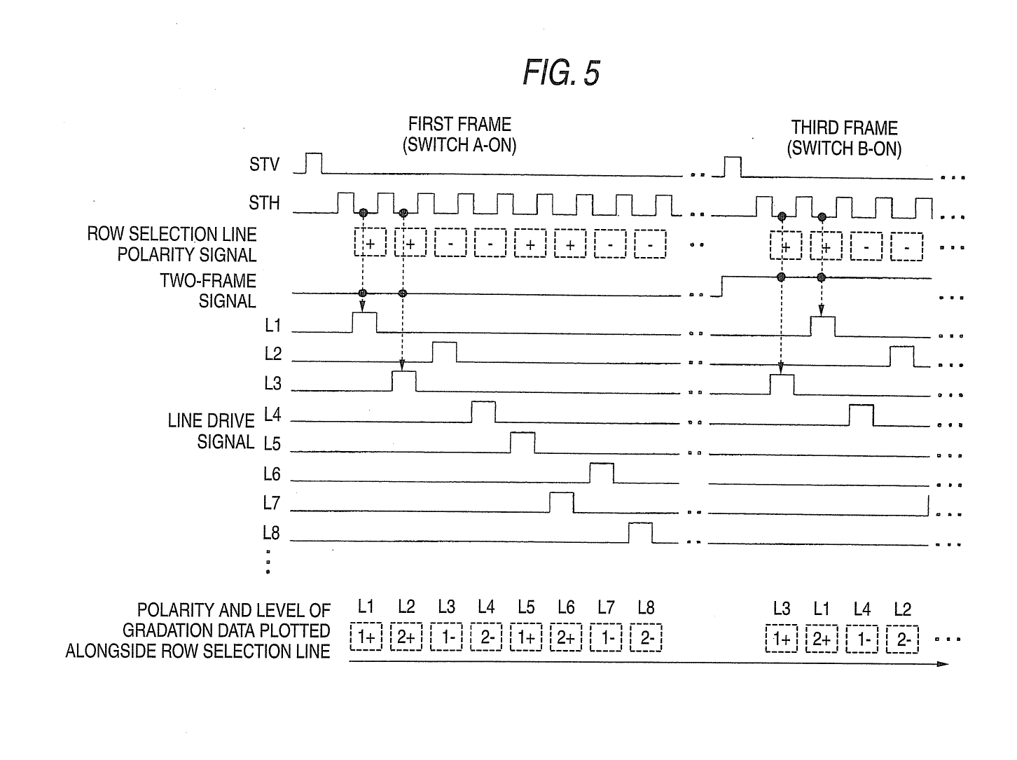

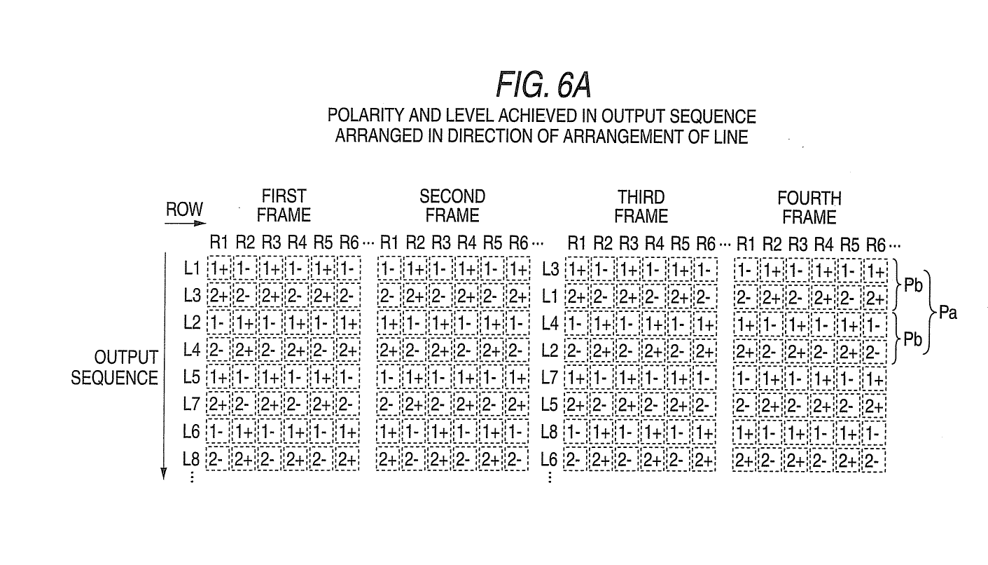

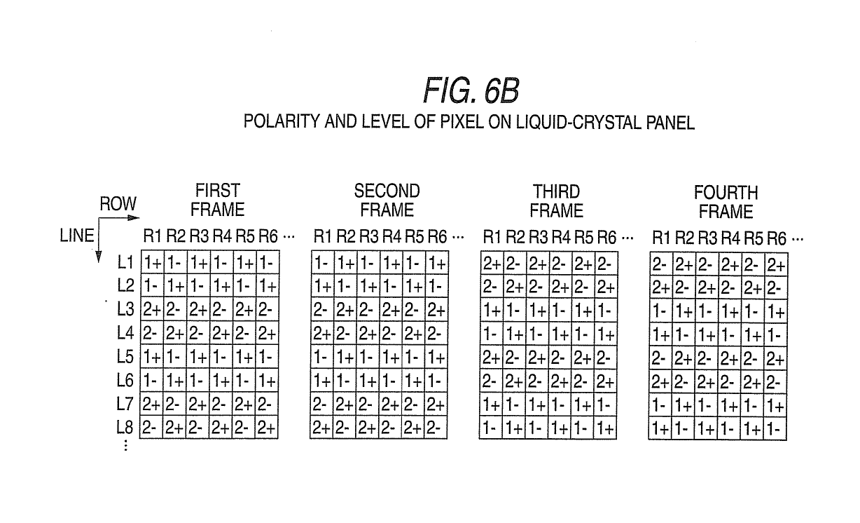

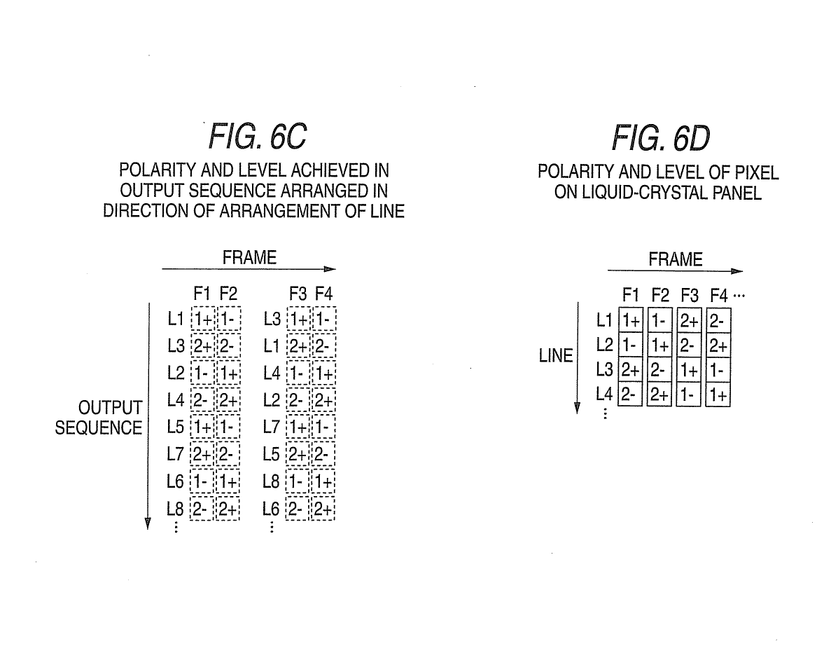

A liquid-crystal display apparatus and a line driver of a first embodiment of the present invention are now described by reference to FIGS. 1 through 6. FIG. 1 is a block diagram schematically showing the configuration of a liquid-crystal display apparatus. FIG. 2 is a block diagram schematically showing the configuration of a line driver used in the liquid-crystal display apparatus. FIG. 3 is a view schematically showing the configuration of a line driver used in the liquid-crystal display apparatus. FIG. 3A is a block diagram, and FIG. 3B is a connection correlation diagram. FIG. 4 is a view schematically showing time-versus-arrival condition of a gradation data voltage supplied to a pixel. FIG. 5 is a timing chart of outputting of gradation data. FIG. 6 is a schematic diagram showing the distribution of polarities and levels of output gradation data, wherein a horizontal axis represents a row or a frame typified by the row, and the vertical axis represents a line. FIG. 6A is a diagram of a distribution arranged in an output sequence; FIG. 6B is a diagram of a distribution associated with pixels on the liquid-crystal panel; FIG. 6C is a view showing, as a frame, one row of each frame shown in FIG. 6A; and FIG. 6D is a view showing, as a frame, one row of each frame shown in FIG. 6B.

As shown in FIG. 1, the liquid-crystal display apparatus 1 has a control circuit 11 having the function of rendering the cycle of a polarity signal longer and re-arranging image data concurrently with write timing; a row driver 21 for supplying gradation data whose polarity is adjusted with matched timing; a line driver 31 which has the function of changing a drive sequence and which performs driving so as to write the gradation data with matched timing; and a liquid-crystal panel 41 where pixels 48—into which the gradation data are to be written at matched timing—are arranged in a matrix pattern.

The control circuit 11 is provided with input data 10, such as image data, a clock signal, a horizontal synchronization signal, and a vertical synchronization signal, and the like, from the outside; and generates a signal for controlling the row driver 21 and the line driver 31. The control circuit 11 can generate a polarity signal for inverting polarity every “n” lines (“n” is an integer which is equal to or greater than 2, and hereinafter also called an “n” line). In the present embodiment, the control circuit generates a polarity signal whose polarity is inverted every two lines. As will be described alter, when a sequence of writing of gradation data does not match the sequence of arrangement of line selection lines 45 of the liquid-crystal panel 41, the control circuit 11 has the function of re-arranging the image data in such a way that the gradation data output from the row driver 21 are output to appropriate line selection lines 45. The re-arrangement function may also be incorporated into; for example, the row driver 21.

The row driver 21 is connected to the control circuit 11 by means of a horizontal scan start signal line 13, an image data bus 14, a data clock line 15, a load signal line 16, a polarity signal line 17, and the like. When the row driver 21 is divided into a plurality of pieces, the horizontal scan start signal line 13 is cascaded to the adjacent row drivers 21. However, the other lines; namely, the image data bus 14, the data clock line 15, the load signal line 16, the polarity signal line 17, and the like, are connected directly to the control circuit 11. Row signal lines 23 connect the row driver 21 to respective row selection lines 43 of the liquid-crystal panel 41.

The line driver 31 is connected to the control circuit 11 by means of the horizontal scan start signal line 13, a vertical scan start signal line 18, a 2-frame signal line 39, and the like. When the line driver 31 is divided into a plurality of pieces, the vertical scan start signal line 18 is cascaded to the adjacent line drivers 31. However, the horizontal scan start signal line 13 is connected directly to the control circuit 11. Line signal lines 33 connect the line driver 31 to respective line selection lines 45 of the liquid-crystal panel 41.

In the liquid-crystal panel 41, the plurality of vertically-extending (in the vertical direction of the drawing) row selection lines (also called “data lines,” or the like) 43 and the plurality of horizontally-extending (in the horizontal direction in the drawing) line selection lines (also called “gate lines” and the like) 45 are arranged, to thus form a matrix (not shown) pattern. A TFT 47 is provided at each of points of intersection of the row selection line 43 and the line selection line 45, wherein the line selection line 45 is connected to a gate of the TFT, and the row selection line 43 is connected to a source of the TFT. The source and the drain of the TFT change their designations according to the direction of an electric current. A pixel (also called a “dot”) 48 having liquid crystal indicated by capacitance is connected to the drain of the TFT 47; in other words, the TFTs 47 and the pixels 48 are arranged in a matrix pattern plotted alongside the row selection lines 43 and the line selection lines 45.

As shown in FIG. 2, the row driver 21 is provided, from the control circuit 11, with a data clock signal, a horizontal scan start signal STH, image data, anode and cathode gradation voltages, a polarity signal, a load signal, and the like. In accordance with the data clock signal, the data control section sequentially latches the image data into the first register, and the image data are stored in a second register for each line by means of the load signal. In image data of each line, a D/A converter of a voltage selection mode, or the like, selects an anode gradation voltage or a cathode gradation voltage appropriate for image data; and outputs the gradation data formed from a gradation voltage to the row selection line 43 from the output circuit by way of the row signal line 23. At that time, the anode gradation voltage or the cathode gradation voltage can be selected in every line or more by means of the polarity signal imparted from the control circuit 11. The horizontal scan start signal STH is output from the data control section, as a cascade signal, to the row driver 21 awaiting the next output.

The configuration of the row driver 21 is analogous to the configuration of a well-known row driver of one-dot inversion type which inverts polarity every line, and polarity is inverted every two lines in the present embodiment. When polarity is inverted every two lines, a polarity signal whose polarity is inverted every two lines by the control circuit 11 is input to the row driver 21. Specifically, the row driver 21 can determine the polarity of gradation data in accordance with the inversion cycle of a desired polarity signal generated by the control circuit 11 (e.g., every “n” lines, where “n” is an integer of two or more). In the meantime, the row driver is analogous to a well-known row driver in terms of the function of inverting gradation data adjacent to each other in a direction along the line so as to assume opposite polarities.

As shown FIG. 3, the line driver 31 has a shift register 35 formed from flip-flops FP (numbers appended to FF are additionally provided, to thus distinguish the flip-flops from each other) assigned to the respective line signal lines 33 connected to the line selection signals 45. The shift register 35 connects the respective flip-flops FF in series and sequentially shifts the vertical scan start signal STV in accordance with the horizontal scan start signal STH sent by the control circuit 11. A gate drive signal (hereinafter called a “drive signal”) assigned to the vertical scan start signal STV is output to the respective line signal lines 33; namely, the lines L (numbers appended to L are added, as necessary, to thus distinguish the lines from each other). Buffers, and the like, are omitted from the drawings.

Conventionally, the flip-flops FF are connected in sequence of arrangement of the line selection lines 45; for instance, a flip-flop FF1 being assigned to a line L1 in a one-to-one correspondence; a flip-flop FF2 being assigned to a line L2 in a one-to-one correspondence; and subsequent flop-flops being sequentially assigned to respective lines in a one-to-one correspondence in the same manner, and the flip-flops produce outputs. However, in the present embodiment, the flip-flops FF are connected to a switching circuit 38 having two separated groups of switches A and B and connected to the line L by way of the selected switches A or B in such a way that an output sequence changes from one frame to another, which will be described later.

Opening and closing of the two groups of switches A and B are controlled by means of a two-frame signal 39a. As shown in FIG. 3B, the flip-flop FF in operation is connected to any of the lines L by way of the switch A or B without involvement of an overlap. For example, the switch A is brought into an ON position in a frame 1 through control operation, and the switch B is brought into an OFF position in a frame 2 through control operation. For example, the switch A is brought into the OFF position in the next frame 3 through control operation, and the switch B is brought into the ON position in a frame 4 through control operation. Likewise, switching is iterated every two continuous frames.

The flip-flop FF1 is connected to the line L1 by way of a switch 38a and to a line L3 by way of a switch B38f. A flip-flop FF2 is connected to a line L3 by way of a switch A38e and to the line L1 by way of a switch B38b. A flip-flop FF3 is connected to the line L2 by way of a switch A38c and to a line L4 by way of a switch B38h. A flip-flop FF4 is connected to the line L4 by way of a switch A38g and to the line L2 by way of a switch 38d. The flip-flops FF5 through FF8 are connected to lines L5 through L8 in such a way that the above correspondence is repeated, and the same also applies to the correspondence between the other flip-flops FF and the other lines L.

Consequently, for instance, in the case of the first and second frames where the switch A and the switch B are brought into the OFF position through control operation, the flip-flop FF1 is connected to the line L1; the flip-flop FF2 is connected to the line L3; the flip-flop FF3 is connected to the line L2; and the flip-flop FF4 is connected to the line L4.

The control circuit 11 changes the sequence of image data supplied to the row driver 21 in accordance with a change in the output sequence from the line driver 31. When no change exits in the output sequence, the output sequence from the line driver 31 is equal to the numerical order of the line L. In the present embodiment, an output is made in sequence of the line L1, the line L3, the line L2, and the line L4. Accordingly, the sequence of image data pertaining to two center lines L of every four consecutive lines L is switched on the basis of the conventional sequence by the control circuit 11, and the image data are then supplied to the row driver 21.

Next will be described a change in the gradation data voltage supplied to the pixels 48. As shown in FIG. 4, a voltage (indicated by a solid line) output from the row driver 21 as gradation data is low at the beginning of an output and tends to increase with elapse of a time. However, a pixel supply voltage (indicated by a wavy line) is much lower at the beginning of an output and increases at a relatively-steep angle with a time so as to catch up with the voltage output from the row driver 21. At the beginning, the pixel supply voltage causes a voltage drop because of wiring in the liquid-crystal panel 41, a resistor of the TFT 47, and the like, but recovers gradually.

For instance, when an anode gradation data voltage is supplied to the three lines L1, L2, and L3, a level 1+ of an applied voltage is attained within a period of the line L1; a higher level 2+ of the applied voltage is achieved within a period of the line L2; and a much higher level 3+ of the applied voltage is achieved within a period of the line L3. The smaller the number of the level, the smaller the absolute value of the voltage. When polarity is inverted, a similar tendency is iterated. Even when the same gradation data are given, it may be the case where a substantial pixel supply voltage will change from the line L1 to the line L2, to thus induce a difference between the lines L, and where failures in image quality, such as discontinuity of brightness and a color shift, may be visually recognized. Although the lines are drawn up to the Line 3 in FIG. 4, the present embodiment is directed to the case where the pixel supply voltage is supplied to the two lines L1 and L2.

As shown in FIG. 5, the line driver 31 of the configuration generates a drive signal in each of the lines L provided alongside the row selection line 43 in response to the vertical scan start signal STV and the horizontal scan start signal STH. The polarities and levels of the gradation data are determined by means of a polarity signal which is inverted every two lines along the row selection line 43 and the two-frame signal 39a which switches the output sequence to the pixels 48; i.e., a level, every two frames. Consequently, the polarities and levels of the gradation data supplied to the line L laid alongside a specific row selection line 43 are provided as; for example, 1+ (a first output of positive polarity), at the lowest level in output sequence or supply, by means of a combination of a distribution (+ or − hereinafter abbreviated as +/−) and the level of a pixel supply voltage (one or two hereinafter abbreviated as 1/2).

Specifically, a drive signal for the line L is supplied at given intervals in synchronism with the horizontal scan start signal STH, and the drive signal is supplied in sequence of the line L1, the line L3, the line L2, the line L4, the line L5, and the like, in accordance with an output from the line driver 31. In synchronism with the timing at which the drive signal for the line L is supplied, the row driver 21 sequentially supplies gradation data to the pixels 48 by way of the row selection lines 43. As a result, the adjacent row selection lines 43 are supplied with the image data inverted so as to assume opposite polarities.

Consequently, the polarities and levels of gradation data supplied to a specific row selection line 43 are inverted every two lines in the output sequence within the first frame. For instance, the positive line L1 (1+) and the positive line L3 (2+) appear, and the negative line L2 (1−) and the negative line L4 (2−) follow. In relation to lines subsequent to a line L5, lines are written in such away that +/− and 1/2 are distributed in analogous combinations. An output sequence of gradation data is not switched within the first and second frames, but the output sequence is switched immediately before initiation of the third frame. The output sequence is not switched within the third and fourth frames.

As shown in FIG. 6A, the distribution of polarities and levels of gradation data is exhibited in such a way that the horizontal axis is aligned with the direction where the rows R are arranged and that the vertical axis is aligned with the output sequence of the lines L. The direction of arrangement of the lines L aligned to the vertical axis becomes analogous to the distribution shown in FIG. 5 where polarity is inverted every two lines. For example, the direction corresponds to a row R1. The direction of arrangement of rows R aligned to the horizontal axis forms a distribution where polarity is inverted in every line. The distribution of polarity becomes analogous to the polarity written by means of a known row driver of two-dot inversion type. Further, although four frames which are consecutive in terms of time are provided, polarity inversion is performed between the frames in the same manner as in the related art. Moreover, the output sequence is changed every two frames by means of switching operation of the switching circuit 38. Specifically, a polarity inversion cycle Pa corresponds to four lines, wherein a polarity unit Pb after which polarity inversion is repeated is two lines. A level inversion cycle corresponds to four frames, wherein a unit after which inversion is repeated is two frames.

As shown in FIG. 6B, the distribution of polarities and levels of gradation data is exhibited in such a way that the horizontal axis is aligned to a direction where the rows R are arranged and that the vertical axis is aligned to the sequence of arrangement of the lines L on the liquid-crystal panel 41. In the direction of arrangement of the rows L aligned to the horizontal axis, the distribution of polarities and levels is identical to a writing sequence shown in FIG. 6A. However, in the direction of arrangement of the lines L aligned to the vertical axis, the distribution differs from the output sequence. For instance, according to the output sequence, the lines are arranged in sequence of the line L1, the line L3, and the like. However, the arrangement of the liquid-crystal panel 41 corresponds to the sequence of the line L1, the line L2, and the like. Consequently, in relation to the adjacent pixels 49 of the liquid-crystal panel 41, gradation data of a different polarity and a different level are distributed on a per-pixel basis along the directions of the vertical and horizontal axes. In the liquid-crystal display apparatus 1, so-called one-dot inversion is implemented. Moreover, the output sequence (a level) is switched every two frames by means of switching operation of the switching circuit 38. In addition, polarity inversion is performed at a point between consecutive frames as in the related art.

FIGS. 6C and 6D simply show the distribution of polarities and levels among the frames. FIG. 6C corresponds to FIG. 6A, only the first row R1 of each frame F (numbers appended to F are added, as required, to thus distinguish the frames from each other) is arranged in the direction of the horizontal axis. FIG. 6D corresponds to FIG. 6B, and the minimum unit of repetition of the first row R1 of each frame R is arranged in the direction of the horizontal axis. The distribution of polarities and levels among the frames F changes while four frames F are taken as a cycle.

Specifically, in the present embodiment, polarities and levels achieved along the row R1 of the line L1 are 1+, 1−, 2+, 2− in sequence of the frame F; and polarities and levels achieved along the row R1 of the line L2 are 1−, 1+, 2−, 2+ in sequence of the frame F. Likewise, polarities and levels achieved along the row R1 of the line L3 are 2+, 2−, 1+, 1− in sequence of the frame F; and polarities and levels achieved along the row R1 of the line L4 are 2−, 2+, 1−, 1+ in sequence of the frame F. In the meantime, for comparison purpose, when the output sequence is not changed by means of switching operation of the switching circuit 38, polarities and levels achieved along the line L1 are 1+, 1−, 1+, 1−; and polarities and levels achieved along the line L2 are 1−, 1+, 1−, 1+. Likewise, polarities and levels achieved along the line L3 are 2+, 2−, 2+, 2−; and polarities and levels achieved along the line L4 are 2−, 2+, 2−, 2+. Levels of gradation data pertaining to the respective pixels are fixed to one or two.

As mentioned above, in the liquid-crystal display apparatus 1, two center lines L of the four lines belonging to the polarity inversion cycle Pa are switched to each other; the line driver 31 is connected to the line selection line 45; and the row driver 21 is driven by means of two-dot inversion of the polarity unit Pb, thereby enabling one-dot inversion operation of the liquid-crystal panel 41. In accordance with the two-frame signal 39, the switching circuit 38 is switched; namely, the connection sequence of the two lines L of the polarity unit Pb is switched, whereby the liquid-crystal display apparatus 1 enables a change the sequence of output to the pixel 48 within single polarity every two frames F while the four frames F are taken as a cycle.

Consequently, when compared with another frame inversion technique, a line inversion technique, or a two-dot inversion technique, the one-dot inversion technique of the present embodiment enables prevention of deterioration of image quality such as flickering. Moreover, according to the one-dot inversion technique, gradation data of different polarities are supplied to all of the adjacent pixels. However, according to the two-dot inversion technique, gradation data of the same polarity are supplied to adjacent two pixels, so that the frequency of supply of gradation data of different polarities to pixels, column signal lines connected thereto, and the like, is reduced one-half (i.e., the frequency of polarity inversion is doubled). Specifically, the amount of power consumed by the liquid-crystal display apparatus 1; especially the amount of power consumed by the column driver 21, can be curtailed significantly, whereby the amount of heat generated by the column driver 21 is suppressed.

As a result of the output sequence for single polarity being changed, gradation data supplied to the same pixel 48 over the duration of the four frames F change in sequence of: for example, 1+, 1−, 2+, 2−. The gradation data can be distributed so as not to cause a timewise level (1/2) offset as well as to prevent dot inversion of polarity between + and −. Specifically, the liquid-crystal display apparatus 1 can provide a more uniform image balanced between a dark (or bright) image exhibiting tendency toward a comparatively-low row drive voltage (the absolute value) (1+ or 1−) and a bright (or dark) image exhibiting tendency toward a comparatively-high row drive voltage (the absolute value) (2+ or 2−).

The line driver 31 changes the output sequence of the output circuit 37 in such a way that an output from the output circuit 37 exhibits a distribution of one-dot inversion on the liquid-display panel 41 and that the output sequence is switched between the frames F. Specifically, as a result of the switching circuit 38 switching the output sequence of the shift register 35, a drive sequence of the line selection line 45 laid alongside the row selection line is changed. Consequently, the line driver 31 enables provision of a more uniform image as well as preventing occurrence of flickering, or the like, of the liquid-crystal display apparatus 1.

### Second Embodiment

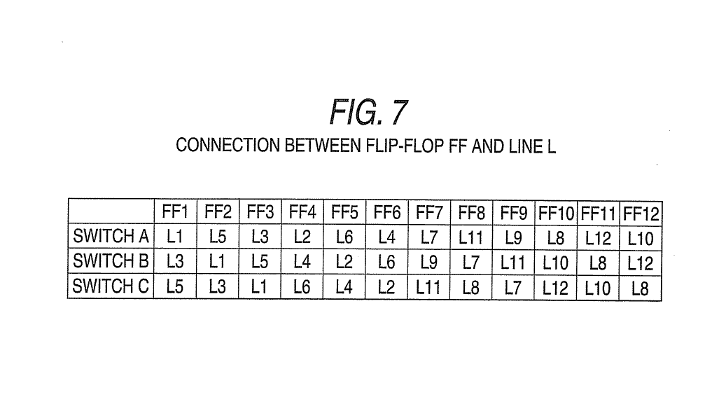

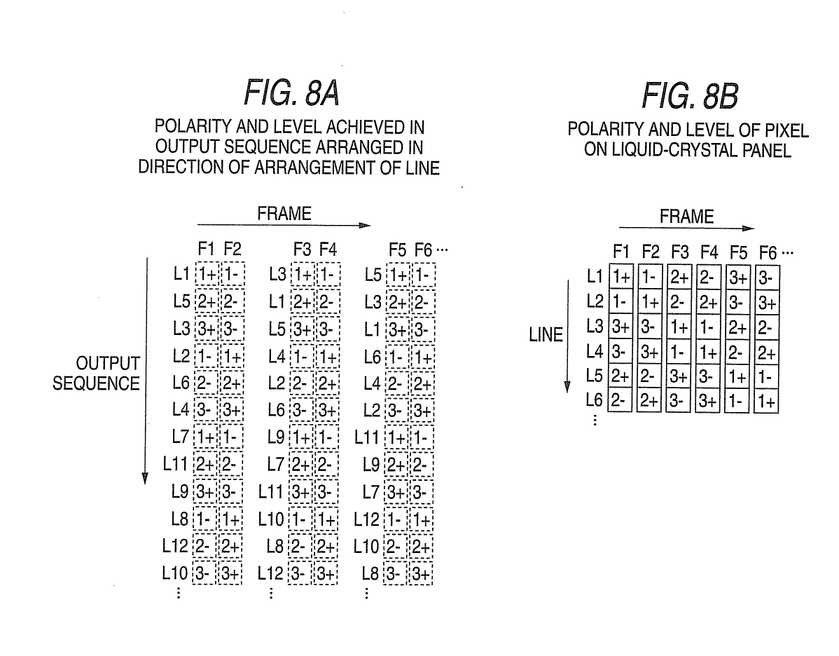

A liquid-crystal display apparatus and a line driver of a second embodiment of the present invention will be described by reference to FIGS. 7 and 8. FIG. 7 is a view schematically showing the correlation of connection between flip-flops of a line driver used in the liquid-crystal display apparatus and lines. FIG. 8 is a schematic diagram showing the distribution of polarities and levels of output gradation data, wherein a horizontal axis represents a frame typified by a row and a vertical axis represents a line. FIG. 8A is a view showing the distribution of polarities and levels arranged in an output sequence, and FIG. 8B is a view showing the distribution of polarities and levels associated with pixels on a liquid-crystal panel. The liquid-crystal display apparatus, the row driver, and the line driver of the present embodiment differ from their counterpart devices of the first embodiment in that the polarity of an output from the line driver is inverted every three lines. In the following descriptions, the same reference numerals are assigned to the same constituent sections, and their repeated explanations are omitted. Explanations are given to different constituent sections.

The liquid-crystal display apparatus of the present embodiment has the row driver 21 of the first embodiment; a line driver embodied by changing the line output sequence of the line driver 31 of the first embodiment; and the control circuit 11 which generates a polarity signal whose polarity is inverted every three lines L and which supplies image data by re-arranging the image data in accordance with the line output sequence of the line driver.

As shown in FIG. 7, in the line driver of the present embodiment, the flip-flops FF are connected to a switching circuit having three switch groups A, B, and C and connected to lines L in such a way that an output sequence is switched from one frame to another by way of the selected switch A, B, or C (see FIG. 3A). The flip-flop FF in operation is connected to any of the lines L by way of the switch A, B, or C without involvement of an overlap. The three switch groups A, B, and C are controlled by means of a two-frame signal 39a in such a way that any one of the switch groups is turned on every two frames F.

Consequently, for instance, in the case of the frames F1 and F2 for which the switch A is controlled so as to be turned on and the switches B and C are controlled so as to be turned off, the flip-flop FF1 is connected to the line L1; the flip-flop FF2 is connected to the line L5; the flip-flop FF3 is connected to the line L3; the flip-flop FF4 is connected to the line L2; the flip-flop FF5 is connected to the line L6; the flip-flop FF6 is connected to the line L4; the flip-flop FF7 is connected to the line L7; the flip-flop FF8 is connected to the line L1; the flip-flop FF9 is connected to the line L9; the flip-flop FF10 is connected to the line L8; the flip-flop FF11 is connected to the line L12; and the flip-flop FF12 is connected to the line L10.

In the present embodiment, polarity is inverted every three lines, and hence a combination of a pixel supply voltage level of gradation data with polarity includes six types: namely, 1+, 2+, 3+, 1−, 2−, and 3−. Consequently, as shown in FIG. 8A, the polarity and level of the frame F1 are expressed as, in the sequence of output of the line L, 1+, 2+, 3+, 1−, 2−, 3−, . . . . Further, the polarity and level of the frame F2 are expressed as, in the sequence of output of the line L, 1−, 2−, 3−, 1+, 2+, 3+, . . . . In relation to the polarity and level of the frame F3, the switch B is turned on by a two-frame signal, and the polarity and level of the frame F3 are expressed as 1+, 2+, 3+, 1−, 2−, 3−, . . . , in the output sequence of the lines L3, L1, L5, L4, L2, L6, . . . . Likewise, switching among the switches A, B, and C and polarity inversion are performed.

As shown in FIG. 8B, the distribution of polarities and levels of the gradation data is shown while the horizontal axis represents a direction in which the frames F are arranged and the vertical axis represents the sequence of arrangement of lines on the liquid-crystal panel 41. In relation to the line L1, 1+, 1−, 2+, 2−, 3+, 3− are provided along the direction of the frame. In relation to the line L2, 1−, 1+, 2−, 2+, 3−, 3+ are provided in the direction of the frame, and the level of the gradation data changes every two frames. In the direction of the line L, the level changes every two lines L. The polarity of the gradation data is inverted on a per-frame basis, and the level of the gradation data exhibits a distribution where all of the levels 1 through 3 appear at the same frequency every six frames corresponding to the unit of repetition, by means of switching operation of the switching circuit.

As mentioned above, the liquid-crystal display apparatus of the present embodiment switches the switching circuit in accordance with the two-frame signal 39a; namely, switches the sequence of connection of the three lines L corresponding to the polarity unit Pb, whereby a sequence of output to the pixels 48 in single polarity can be changed every two frames F while the six frames F are taken as a cycle.

Consequently, the present embodiment yields an effect similar to that yielded by the first embodiment. In addition, since polarity is inverted every three lines L (the cycle of polarity inversion is three times the cycle of one dot inversion), the amount of power consumed by the liquid-crystal display apparatus; especially, the amount of power consumed by the line driver 21, can be curtailed further, and the amount of heat generated by the line driver 21 is reduced. Moreover, the gradation data supplied to the same pixel 48 over the duration of the six frames F can be distributed in a more elaborate manner by means of changing the sequence of output in single polarity, so as to change in sequence of: for example, 1+, 1−, 2+, 2−, 3+, 3−; that is, in such a way that a deviation does not arise timewise in three levels (1/2/3) in conjunction with dot inversion of +/−. Accordingly, a more uniform image can be provided.

The line driver of the present embodiment changes the output sequence of the output circuit in such a way that an output from the output circuit exhibits a distribution of one-dot inversion on the liquid-crystal display panel 41 and that the output sequence is switched from one frame F to another frame F. Specifically, the drive sequence of the line selection line 45 laid alongside the row selection ling is changed as a result of the output sequence of the shift register being switched by the switching circuit. Consequently, the line driver can provide a more uniform image, as well as preventing occurrence of flickering, or the like, in the liquid-crystal display apparatus.

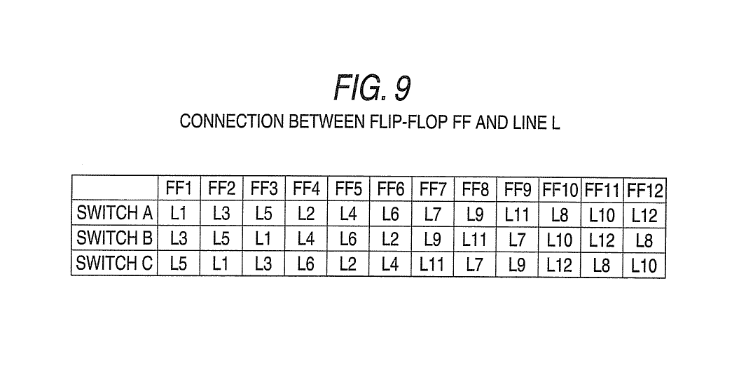

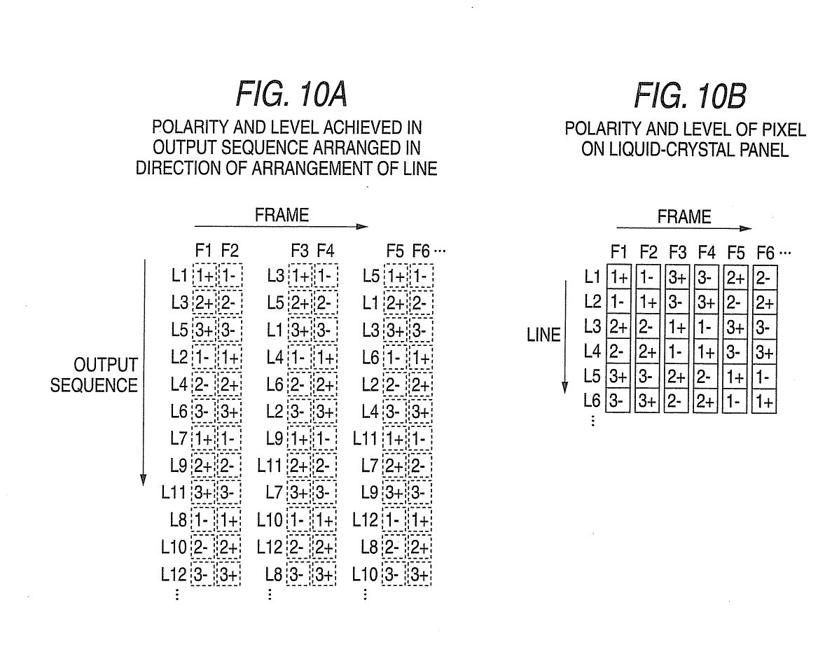

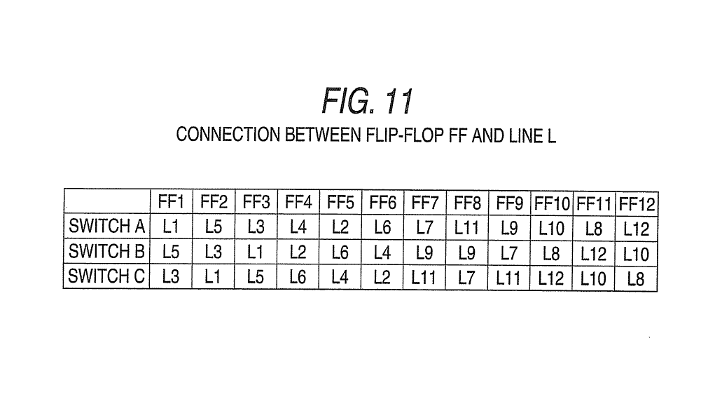

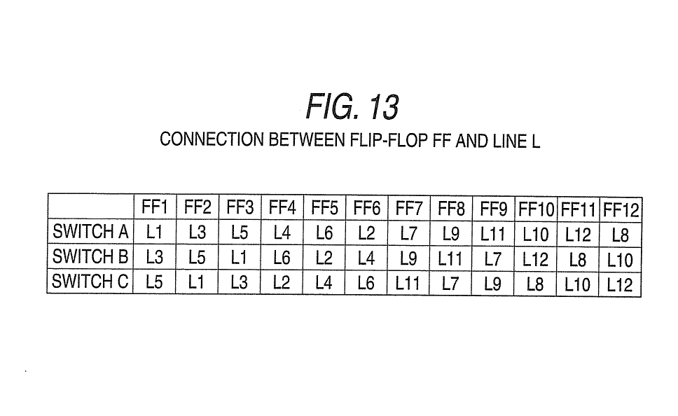

First through third modifications of the second embodiment of the present invention will now be described by reference to FIGS. 9 through 14. FIG. 9, FIG. 11, and FIG. 13 are views schematically showing the correlation of connection between flip-flops and lines of the line drivers. FIGS. 10, 12, and 14 correspond to FIGS. 9, 11, and 13, respectively; and the drawings are schematic diagrams showing the distribution of polarities and levels of output gradation data, wherein the horizontal axis represents frames typified by rows and the vertical axis represents lines. In the respective drawings FIGS. 10A, 12A, and 14A are views showing the distribution of polarities and levels arranged in an output sequence, and FIGS. 10B, 12B, and 14B are views showing the distribution of polarities and levels allocated to pixels on a liquid-crystal panel. The liquid-crystal display apparatus, the row driver, and the line driver of the first to third modifications are analogous to their counterpart devices of the second embodiment. The devices are analogous to their counterpart devices of the second embodiment in that the polarity of an output from the line driver is inverted every three lines, but differ from each other in terms of the correlation of connection between the flip-flops and the lines. In the following descriptions, the same reference numerals are assigned to the constituent sections that are the same as those of the first and second embodiments, and their repeated explanations are omitted. Explanations are given to different constituent sections.

As shown in FIG. 9, in the line driver of the first modification, the flip-flops FF are connected to a switching circuit having three switch groups A, B, and C and connected to the lines L in such a way that an output sequence is switched from one frame to another by way of the selected switch A, B, or C (see FIG. 3A).

For instance, in the case of the frames F1 and F2 for which the switch A is controlled so as to be turned on and the switches B and C are controlled so as to be turned off, the flip-flop FF1 is connected to the line L1; the flip-flop FF2 is connected to the line L3; the flip-flop FF3 is connected to the line L5; the flip-flop FF4 is connected to the line L2; the flip-flop FF5 is connected to the line L4; the flip-flop FF6 is connected to the line L6; the flip-flop FF7 is connected to the line L7; the flip-flop FF8 is connected to the line L9; the flip-flop FF9 is connected to the line L11; the flip-flop FF10 is connected to the line L8; the flip-flop FF11 is connected to the line L10; and the flip-flop FF12 is connected to the line L12.

As shown in FIG. 10A, the polarity and level of the frame F1 are expressed as, in the sequence of output of the line L, 1+, 2+, 3+, 1−, 2−, 3−, . . . . Further, the polarity and level of the frame F2 are expressed as, in the sequence of output of the line L, 1−, 2−, 3−, 1+, 2+, 3+, . . . . In relation to the polarity and level of the frame F3, the switch B is turned on by the a two-frame signal 39a, and the polarity and level of the frame F3 are expressed as 1+, 2+, 3+, 1−, 2−, 3−, . . . , in the output sequence of the lines L3, L5, L1, L4, L6, L2, Likewise, switching among the switches A, B, and C and polarity inversion are performed.

As shown in FIG. 10B, the distribution of polarities and levels of the gradation data is shown while the horizontal axis represents a direction in which the frames F are arranged and the vertical axis represents the sequence of arrangement of lines on the liquid-crystal panel 41. In relation to the line L1, 1+, 1−, 3+, 3−, 2+, 2− are provided along the direction of the frame F. In relation to the line L2, 1−, 1+, 3−, 3+, 2−, 2+ are provided in the direction of the frame F, and the level of the gradation data changes every two lines L. The polarity of the gradation data is inverted in every frame F, and the level of the gradation data exhibits a distribution where all of the levels 1 through 3 appear at the same frequency every six frames corresponding to the unit of repetition, by means of switching operation of the switching circuit. As in the second embodiment, the level changes in every two lines L.

As mentioned above, the liquid-crystal display apparatus of the first modification of the second embodiment switches the switching circuit in accordance with the two-frame signal 39a; namely, switches the sequence of connection of the three lines L corresponding to the polarity unit Pb, whereby a sequence of output to the pixels 48 in single polarity can be changed every two frames F while the six frames F are taken as a cycle. Consequently, the first modification of the second embodiment yields an effect analogous to that yielded by the second embodiment.

The line driver of the first modification yields an effect analogous to that yielded by the second embodiment.

As shown in FIG. 11, in the line driver of the second modification, the flip-flops FF are connected to a switching circuit having three switch groups A, B, and C and connected to the lines L in such a way that an output sequence is switched from one frame to another by way of the selected switch A, B, or C (see FIG. 3A).

For instance, in the case of the frames F1 and F2 for which the switch A is controlled so as to be turned on and the switches B and C are controlled so as to be turned off, the flip-flop FF1 is connected to the line L1; the flip-flop FF2 is connected to the line L5; the flip-flop FF3 is connected to the line L3; the flip-flop FF4 is connected to the line L4; the flip-flop FF5 is connected to the line L2; the flip-flop FF6 is connected to the line L6; the flip-flop FF7 is connected to the line L7; the flip-flop FF8 is connected to the line L11; the flip-flop FF9 is connected to the line L9; the flip-flop FF10 is connected to the line L10; the flip-flop FF11 is connected to the line L8; and the flip-flop FF12 is connected to the line L12.

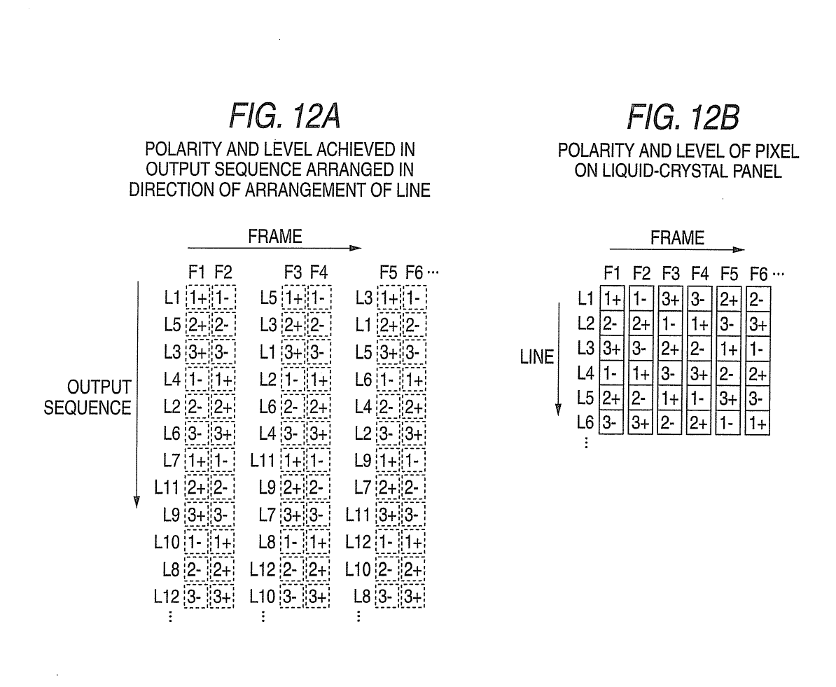

As shown in FIG. 12A, the polarity and level of the frame F1 are expressed as, in the sequence of output of the line L, 1+, 2+, 3+, 1−, 2−, 3−, . . . . Further, the polarity and level of the frame F2 are expressed as, in the sequence of output of the line L, 1−, 2−, 3−, 1+, 2+, 3+, . . . . In relation to the polarity and level of the frame F3, the switch B is turned on by the a two-frame signal 39a, and the polarity and level of the frame F3 are expressed as 1+, 2+, 3+, 1−, 2−, 3−, . . . , in the output sequence of the lines L5, L3, L1, L2, L6, L4, . . . . Likewise, switching among the switches A, B, and C and polarity inversion are performed.

As shown in FIG. 12B, the distribution of polarities and levels of the gradation data is shown while the horizontal axis represents a direction in which the frames F are arranged and the vertical axis represents the sequence of arrangement of lines on the liquid-crystal panel 41. In relation to the line L1, 1+, 1−, 3+, 3−, 2+, 2− are provided along the direction of the frame F. In relation to the line L2, 2−, 2+, 1−, 1+, 3−, 3+ are provided in the direction of the frame F, and the level of the gradation data changes in every line L. The polarity of the gradation data is inverted in every frame F, and the level of the gradation data exhibits a distribution where all of the levels 1 through 3 appear at the same frequency every six frames corresponding to the unit of repetition, by means of switching operation of the switching circuit. In contrast with the first modification, the level changes in every line L.

As mentioned above, the liquid-crystal display apparatus of the second modification of the second embodiment switches the switching circuit in accordance with the two-frame signal 39a; namely, switches the sequence of connection of the three lines L corresponding to the polarity unit Pb, whereby a sequence of output to the pixels 48 in single polarity can be changed every two frames F while the six frames F are taken as a cycle. Consequently, the second modification of the second embodiment yields an effect similar to that yielded by the first modification of the second embodiment. Since the level changes in each line L, a more uniform image can be provided.

In addition to yielding an effect analogous to that yielded by the second embodiment, the line driver of the second modification enables provision of a more uniform image.

As shown in FIG. 13, in the line driver of the third modification, the flip-flops FF are connected to a switching circuit having three switch groups A, B, and C and connected to the lines L in such a way that an output sequence is switched from one frame to another by way of the selected switch A, B, or C (see FIG. 3A).

For instance, in the case of the frames F1 and F2 for which the switch A is controlled so as to be turned on and the switches B and C are controlled so as to be turned off, the flip-flop FF1 is connected to the line L1; the flip-flop FF2 is connected to the line L3; the flip-flop FF3 is connected to the line L5; the flip-flop FF4 is connected to the line L4; the flip-flop FF5 is connected to the line L6; the flip-flop FF6 is connected to the line L2; the flip-flop FF7 is connected to the line L7; the flip-flop FF8 is connected to the line L9; the flip-flop FF9 is connected to the line L11; the flip-flop FF10 is connected to the line L10; the flip-flop FF11 is connected to the line L12; and the flip-flop FF12 is connected to the line L8.

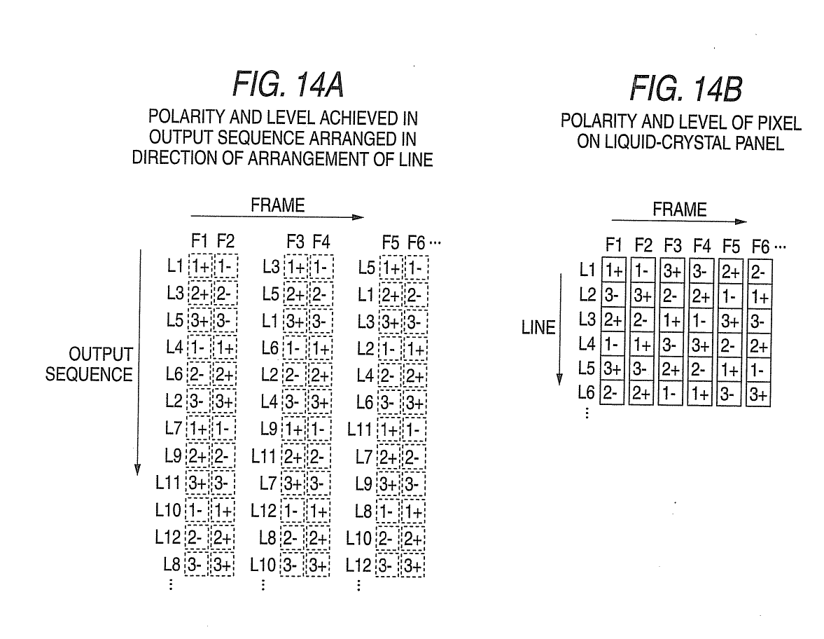

As shown in FIG. 14A, the polarity and level of the frame F1 are expressed as, in the sequence of output of the line L, 1+, 2+, 3+, 1−, 2−, 3−, . . . . Further, the polarity and level of the frame F2 are expressed as, in the sequence of output of the line L, 1−, 2−, 3−, 1+, 2+, 3+, . . . . In relation to, the polarity and level of the frame F3, the switch B is turned on by the a two-frame signal 39a, and the polarity and level of the frame F3 are expressed as 1+, 2+, 3+, 1−, 2−, 3−, . . . , in the output sequence of the lines L3, L5, L1, L6, L2, L4, . . . . Likewise, switching among the switches A, B, and C and polarity inversion are performed.

As shown in FIG. 14B, the distribution of polarities and levels of the gradation data is shown while the horizontal axis represents a direction in which the frames F are arranged and the vertical axis represents the sequence of arrangement of lines on the liquid-crystal panel 41. For instance, in relation to the line L1, 1+, 1−, 3+, 3−, 2+, 2− are provided along the direction of the frame F. In relation to the line L2, 3−, 3+, 2−, 2+, 1−, 1+ are provided in the direction of the frame F, and the level of the gradation data changes in every line L. The polarity of the gradation data is inverted in every frame F, and the level of the gradation data exhibits a distribution where all of the levels 1 through 3 appear at the same frequency every six frames corresponding to the unit of repetition, by means of switching operation of the switching circuit. As in the second modification, the level changes in every line L.

As mentioned above, the liquid-crystal display apparatus of the third modification of the second embodiment switches the switching circuit in accordance with the two-frame signal 39a; namely, switches the sequence of connection of the three lines L corresponding to the polarity unit Pb, whereby a sequence of output to the pixels 48 in single polarity can be changed every two frames F while the six frames F are taken as a cycle. Consequently, the third modification of the second embodiment yields an effect analogous to that yielded in the second modification.

The line driver of the third modification yields an effect analogous to that yielded by the second modification.

### Third Embodiment

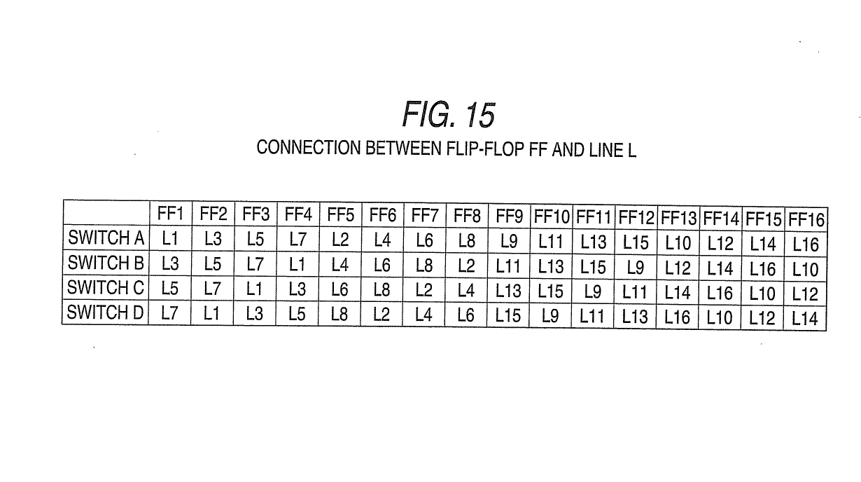

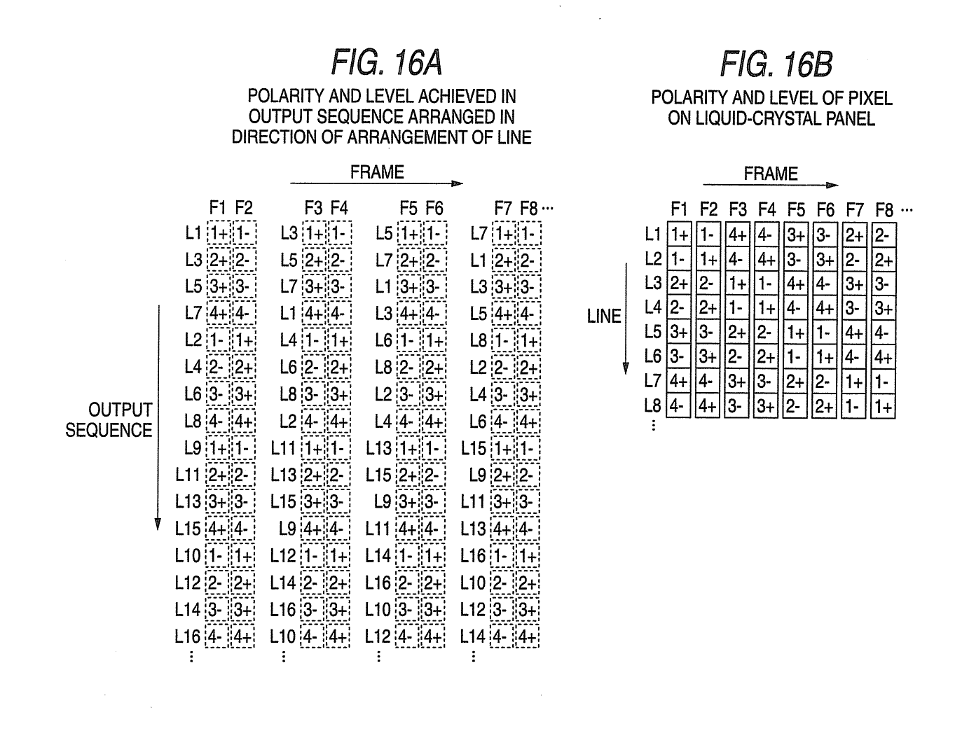

A liquid-crystal display apparatus and a line driver of a third embodiment of the present invention will be described by reference to FIGS. 15 and 16. FIG. 15 is a view schematically showing the correlation of connection between flip-flops of a line driver used in the liquid-crystal display apparatus and lines. FIG. 16 is a schematic diagram showing the distribution of polarities and levels of output gradation data, wherein the horizontal axis represents frames typified by rows and the vertical axis represents lines. FIG. 16A is a view showing the distribution of polarities and levels arranged in an output sequence, and FIG. 16B is a view showing the distribution of polarities and levels allocated to pixels on a liquid-crystal panel. The liquid-crystal display apparatus, the row driver, and the line driver of the present embodiment differ from their counterpart devices of the first and second embodiments in that the polarity of an output from the line driver is inverted every four lines. In the following descriptions, the same reference numerals are assigned to the same constituent sections of the first and second embodiments, and their repeated explanations are omitted. Explanations are given to different constituent sections.

The liquid-crystal display apparatus of the present embodiment has the row driver 21 of the first embodiment; a line driver embodied by changing the line output sequence of the line driver 31 of the first embodiment; and the control circuit 11 which generates a polarity signal whose polarity is inverted every four lines and which supplies image data by re-arranging the image data in accordance with the line output sequence of the line driver.

As shown in FIG. 15, in the line driver of the present embodiment, the flip-flops FF are connected to a switching circuit having four switch groups A, B, C, and D and connected to lines L in such a way that an output sequence is switched from one frame to another by way of the selected switch A, B, C, or D (see FIG. 3A). The flip-flop FF in operation is connected to any of the lines L by way of the switch A, B, C, or D without involvement of an overlap. The four switch groups A, B, C, and D are controlled by means of the two-frame signal 39a in such a way that any one of the switch groups is turned on every two frames F.

Consequently, for instance, in the case of the frames F1 and F2 for which the switch A is controlled so as to be turned on and the switches B and C are controlled so as to be turned off, the flip-flop FF1 is connected to the line L1; the flip-flop FF2 is connected to the line L3; the flip-flop FF3 is connected to the line L5; the flip-flop FF4 is connected to the line L7; the flip-flop FF5 is connected to the line L2; the flip-flop FF6 is connected to the line L4; the flip-flop FF7 is connected to the line L6; the flip-flop FF8 is connected to the line L8; the flip-flop FF9 is connected to the line L9; the flip-flop FF10 is connected to the line L11; the flip-flop FF11 is connected to a line L13; the flip-flop FF12 is connected to a line L15; a flip-flop FF13 is connected to the line L10; a flip-flop FF14 is the line L12; a flip-flop 15 is connected to a line L14; and a flip-flop F16 is connected to a line L16.

In the present embodiment, polarity is inverted every four lines, and hence a combination of a pixel supply voltage level of gradation data with polarity includes eight types: namely, 1+, 2+, 3+, 4+, 1−, 2−, 3−, and 4−. Consequently, as shown in FIG. 16A, the polarity and level of the frame F1 are expressed as, in the sequence of output of the line L, 1+, 2+, 3+, 4+, 1−, 2−, 3−, 4−, . . . . Further, the polarity and level of the frame F2 are expressed as, in the sequence of output of the line L, 1−, 2−, 3−, 4−, 1+, 2+, 3+, 4+, . . . . In relation to the polarity and level of the frame F3, the switch B is turned on by the two-frame signal, and the polarity and level of the frame F3 are expressed as 1+, 2+, 3+, 4+, 1−, 2−, 3−, 4−, . . . , in the output sequence of the lines L3, L5, L7, L1, L4, L6, L8, L2, . . . . Likewise, switching among the switches A, B, C, and D and polarity inversion are performed.

As shown in FIG. 16B, the distribution of polarities and levels of the gradation data is shown while the horizontal axis represents a direction in which the frames F are arranged and the vertical axis represents the sequence of arrangement of lines on the liquid-crystal panel 41. In relation to the line L1, 1+, 1−, 4+, 4−, 3+, 3−, 2+, and 2− are provided along the direction of the frame F. In relation to the line L2, 1−, 1+, 4+, 4−, 3−, 3+, 2−, 2+ are provided in the direction of the frame F, and the level of the gradation data changes every two frames. In the direction of the line L, the level changes every two lines L. The polarity of the gradation data is inverted in every frame F, and the level of the gradation data exhibits a distribution where all of the levels 1 through 4 appear at the same frequency every eight frames corresponding to the unit of repetition, by means of switching operation of the switching circuit.

As mentioned above, the liquid-crystal display apparatus of the present embodiment switches the switching circuit in accordance with the two-frame signal 39a; namely, switches the sequence of connection of the four lines L corresponding to the polarity unit Pb, whereby a sequence of output to the pixels 48 in single polarity can be changed every two frames F while the eight frames F are taken as a cycle.

Consequently, the present embodiment yields an effect similar to that yielded by the first embodiment. In addition, since polarity is inverted every four lines L (the cycle of polarity inversion becomes four times the cycle of one dot inversion), the amount of power consumed by the liquid-crystal display apparatus; especially, the amount of power consumed by the line driver 21, can be curtailed further, and the amount of heat generated by the line driver 21 is reduced. Moreover, the gradation data supplied to the same pixel 48 over the duration of the eight frames F can be distributed in a more elaborate manner by means of changing the sequence of output in single polarity, so as to change in sequence of: for example, 1+, 1−, 4+, 4−, 3+, 3−, 2+, 2−; that is, in such a way that a deviation does not arise timewise in four levels (1/2/3/4) in conjunction with dot inversion of +/−. Accordingly, a more uniform image can be provided.

In addition to yielding an effect analogous to that yielded by the first embodiment, the line driver of the present embodiment enables provision of a more uniform image.

Needless to say, a modification of the third embodiment can be implemented by means of changing the line output sequence as in the first to third modifications of the second embodiment.

### Fourth Embodiment

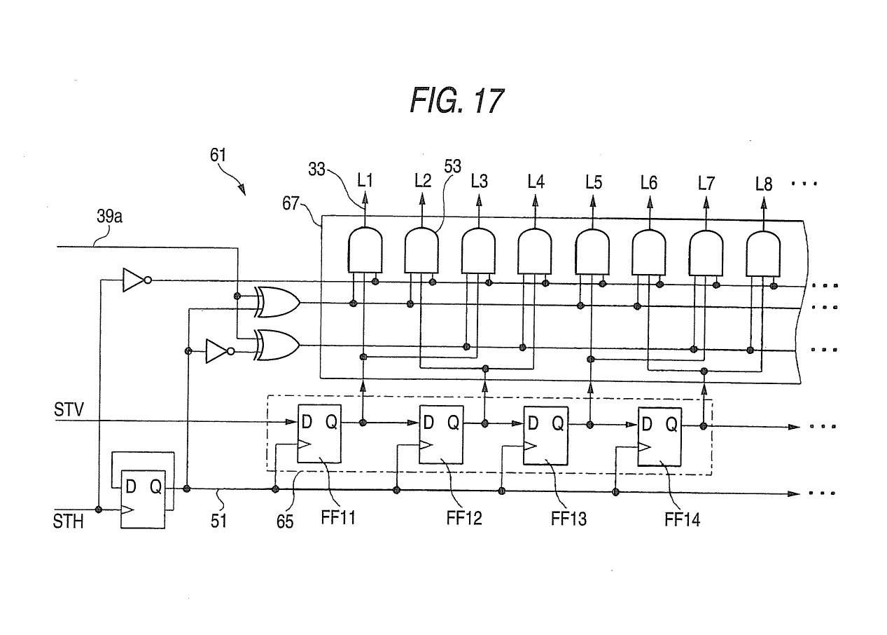

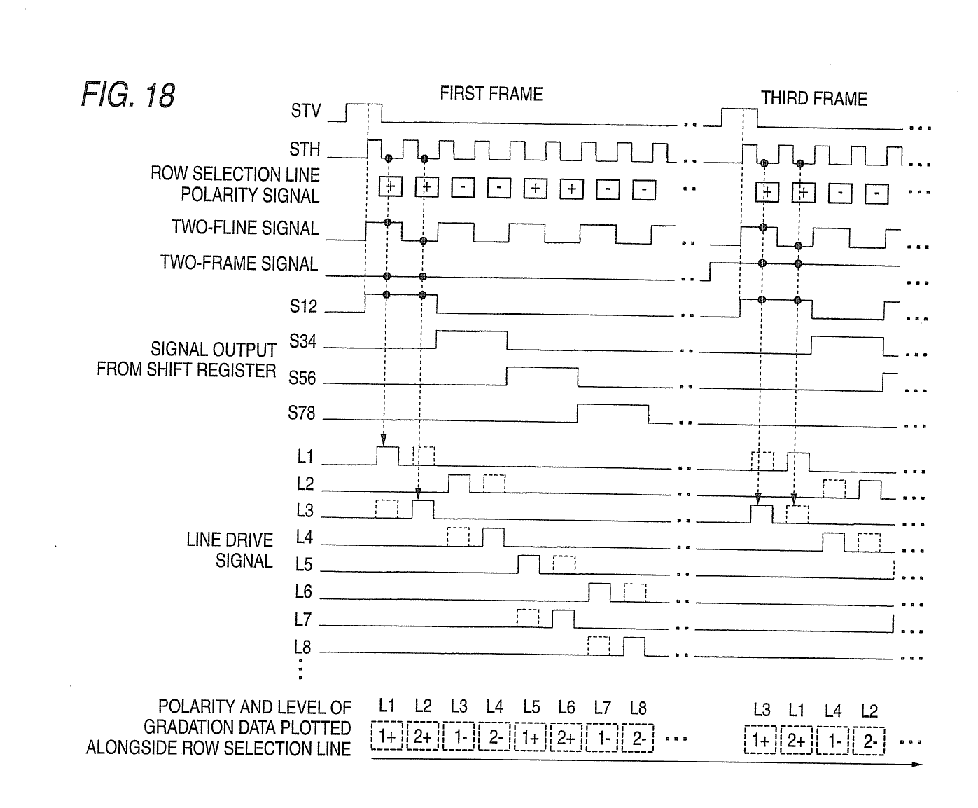

A liquid-crystal display apparatus and a line driver of a fourth embodiment of the present invention will be described by reference to FIGS. 17 and 18. FIG. 17 is a view schematically showing the configuration of a line driver used in the liquid-crystal display apparatus. FIG. 18 is a timing chart used for writing gradation data. The liquid-crystal display apparatus, the row driver, and the line driver of the present embodiment differ from their counterpart devices of the first embodiment in that the output circuit of the line driver is configured as a logic gate. In the following descriptions, the same reference numerals are assigned to the same constituent sections of the first embodiment, and their repeated explanations are omitted. Explanations are given to different constituent sections.

As shown in FIG. 17, a line driver 61 of the present embodiment can be replaced with the line driver 31 in the liquid-crystal driver 1 of the first embodiment shown in FIG. 1. The line driver 61 is connected to the control circuit 11 by means of the horizontal scan start signal line 13, the vertical scan start signal line 18, the two-frame signal line 39, and the like.

The line driver 61 has a shift register 65 formed from flip-flops FF, wherein each of the flip-flops FF is assigned to two line signal lines 33 connected to the line selection lines 45. In the shift register 65, the flip-flops FF generate a two-line signal 51 in accordance with the horizontal scan start signal line STH sent from the control circuit 11, and the thus-generated signal is supplied. In the shift register 65, the respective flip-flops FF are connected in series, and the vertical scan start signal STV is sequentially shifted. A gate drive signal corresponding to the vertical scan start signal STV is input to each of the line signal lines 33; namely, an AND gate 53 connected to the line L. Specifically, a flip-flop FF11 is connected to an AND gate 53 connected to lines L1 and L3; a flip-flop 12 is connected to the AND gate 53 connected to lines L2 and L4; a flip-flop 13 is connected to the AND gate 53 connected to lines L5 and L7; and a flip-flop 14 is connected to the AND gate 53 connected to lines L6 and L8. Each of the flip-flops FF outputs a signal for every two lines.

The horizontal scan start signal STH is connected to the AND gate 53 by way of a NOT gate. The two-frame signal 39a is connected to two EXOR gates. The two-line signal 51 is connected to the AND gate 53 connected to the lines L1, L2, L5, and L6 by way of one EXOR gate, as well as being connected to the AND gate 53 connected to the lines L3, L4, L7, and L8 by way of the other EXOR gate.

By means of the above circuit, as shown in FIG. 18, the line driver 61 generates a signal for driving the line L from the vertical scan start signal STV, the horizontal scan start signal STH, the two-line signal 51, the two-frame signal 39a, and a signal output from the shift register 65. The flip-flops FF of the shift register 65 generates shifted signals S12, S34, S56, and S78 by means of performing shifting operation every two lines L in accordance with the two-line signal 51. A scan sequence is switched by means of combining a signal output from the shift register 65, the two-frame signal 39a, and the two-line signal 51. For instance, a signal from the flip-flop F11 is output to the AND gate 53 connected to the line L1 and the AND gate 53 connected to the line L3. When a second frame signal 39a is in a LOW state in the first frame, the ANG gate 53 selects the first signal and outputs the thus-selected signal to the line L1; and selects a second signal and outputs the thus-selected signal to the line L3. A broken line of the line drive signal means that the signal is not selected. In the third frame, when the two-frame signal 39a is in a HIGH state, the first signal is conversely selected and output to the line L3, and the second signal is selected and output to the line L1. The polarities and levels of the gradation data are determined by means of a polarity signal which is provided along the row selection line 43 and which is inverted every two lines and the two-frame signal 39a which switches the sequence of output to the pixels 48 in every two frames F; namely, performs level switching.

Consequently, the polarity and level of gradation data which are provided along a specific row selection line 43 are inverted, in an output sequence, every two lines within a first frame. The polarity and level are inverted as; for instance, the positive line L1 (1+) and the line L3 (2+), and subsequently the negative line L2 (1−) and the line L4 (2−). In a line L5 and subsequent lines, the polarity and level are written in such a way that +/− and 1/2 are distributed in similar combinations. In the first and second frames, the sequence of output of gradation data is not switched, and the output sequence is switched immediately before commencement of the third frame. The output sequence is not switched within the third and fourth frames. The polarity of the frame is incessantly inverted. In subsequent operations, the gradation data output to the lines L, the rows R, and the frames F are written as shown in FIG. 6 of the first embodiment.

As mentioned above, the output circuit of the line driver is formed from a logic gate, whereby the liquid-crystal display apparatus of the present embodiment can exhibit the distribution of gradation data analogous to that formed by the liquid-crystal display apparatus 1 of the first embodiment. Accordingly, the effects yielded by the liquid-crystal display apparatus 1 and the line driver 31 of the first embodiment are also yielded by the liquid-crystal display apparatus and the line driver 61 of the present embodiment.

A modification of the fourth embodiment can be formed and implemented as in the case of the second embodiment derived from the first embodiment, the first to third modifications of the second embodiment, and the third embodiment. Specifically, a modification in which the polarity of gradation data output from the row driver 21 is inverted every three lines or four lines can be implemented by means of forming the output circuit of the line driver from the logic gate configuration.

The present invention is not limited to the above embodiments and can be implemented in various modified forms within the scope of the gist of the present invention.

For instance, in the above embodiments, an example where the sequence of output of the line drive signal is changed by way of the switching circuit or the output circuit of logic gate configuration is provided. The sequence of output of a line drive signal may also be changed by means of a decoder or a logic circuit using a lookup table, memory, or the like, or another circuit or means capable of switching the sequence of output of a line drive signal; and the like.

Although the above embodiment provides an example in which the sequence of output of a line drive signal is changed by way of the switching circuit in the line driver or the output circuit of a logic gate configuration, the output sequence can also be changed by means of providing wiring of a tape carrier package, wiring on a liquid-crystal panel, and the like, with circuit or means for changing an output sequence, in addition to providing the switching circuit or the output circuit interposed between the line driver and the line selection line.

The above embodiments show the examples up to the example where polarity is inverted every four line selection lines (the polarity unity is four lines, and the cycle of polarity inversion is eight lines). However, the polarity unit can surpass four lines.

The above embodiments provide the example where the sequence of output of gradation data is switched every two frames. However, the sequence of output can be changed every frame. In this case, in relation to; for example, a certain pixel, the polarity and level of gradation data are switched, in frame sequence, as 1+, 2−, 1+, 2−, . . . , and the combination of polarity and level are fixed. Hence, an attempt can be made to make image quality uniform at higher speed by means of performing control operation so as to prevent occurrence of variations in the absolute value of a voltage, which would otherwise arise during switching of polarity.

Conceivable configurations of the present invention are as described in the following additional remarks.

(Additional Remark 1) A liquid-crystal display apparatus includes:

a liquid-crystal panel having pixels which correspond to positions of intersection of a plurality of row selection lines and a plurality of line selection lines, which are driven by line drive signals from the line selection lines by way of thin-film transistors connected to the row selection lines and the line selection lines, and which are supplied with gradation data from the row selection lines;

row drivers that generate a voltage corresponding to the supplied image data and supply the row selection lines with the gradation data for which polarities of the voltage supplied to the pixels corresponding to the line selection lines are inverted every “n” line selection lines (“n” is an integer of two or more);

line drivers which drive, in a first drive sequence differing from a sequence of arrangement on the liquid-crystal panel, the line selection lines in a group that spur supply of the gradation data, on an assumption that the gradation data supplied to the pixels connected to every “m” line selection lines (“m” is an integer of two or more; m≧n) are taken as a group, and which further drives the line selection lines, in a second drive sequence differing from the sequence of arrangement on the liquid-crystal panel, every “k” frames (“k” is an integer of one or more); and

a control circuit for supplying the image data to the row drivers.

(Additional Remark 2) The liquid-crystal display apparatus defined in Additional Remark 1 is that at least either of the row driver and the control circuit have the function for re-arranging the image data along the first or second drive sequence.

(Additional Remark 3) The liquid-crystal display apparatus defined in Additional Remarks 1 is that reference numeral “m” is four; reference numeral “n” is two; and reference numeral “k” is one.

(Additional Remark 4) The liquid-crystal display apparatus defined in Additional Remarks 1 is that reference numeral “m” is six; reference numeral “n” is three; and reference numeral “k” is two.

(Additional Remark 5) The liquid-crystal display apparatus defined in Additional Remarks 1 is that reference numeral “m” is eight; reference numeral “n” is four; and reference numeral “k” is two.

What is claimed is:

1. A liquid-crystal display apparatus comprising:
a liquid-crystal panel that includes pixels arranged at positions where a plurality of row selection lines and a plurality of line selection lines intersect, the pixels driven by activating thin-film transistors connected to the row selection lines and the line selection lines;
a row driver generating a voltage based on gradation data and applying the voltage to the row selection lines by inverting a polarity of the voltage every “n” sets of the row selection lines; and
a line driver driving every “m” sets of the line selection lines in one of a first drive order and a second drive order that are different from an arrangement order of the line selection lines on the liquid-crystal panel,
wherein the line driver repeatedly performs an operation including:
(1) driving the line selection lines in the first drive order for “k” flames; and
(2) driving the line selection lines in the second drive order for “k” flames.

2. The liquid-crystal display apparatus according to claim 1,
wherein the “n” sets are 2 sets;
wherein the “m” sets are 4 sets; and
wherein the “k” flames are 2 flames.

3. The liquid-crystal display apparatus according to claim 1,
wherein the voltage applied to the pixels has inverse polarity to adjacent pixels;

4. The liquid-crystal display apparatus according to claim 1, wherein the line driver includes a shift register and a switching device that is connected between the shift register and the line selection lines.

5. The liquid-crystal display apparatus according to claim 4,
wherein the switching device includes a switching element.

6. The liquid-crystal display apparatus according to claim 4,
wherein the switching device includes a logical gate.

7. The liquid-crystal display apparatus according to claim 1,
wherein the line driver further drives every “m” sets of the line selection lines in a third drive order that is different from an arrangement order of the line selection lines on the liquid-crystal panel,
wherein the operation further including:
(3) driving the line selection lines in the third drive order for “k” flames.

8. The liquid-crystal display apparatus according to claim 7,
wherein the “n” sets are 3 sets; and
wherein the “m” sets are 6 sets.

9. The liquid-crystal display apparatus according to claim 7,
wherein the first, second and third drive orders are set so that an averaged level of the gradation data is equal to each other between the pixels corresponding to the “n” sets of the line selection lines.

10. The liquid-crystal display apparatus according to claim 1,
wherein the line driver further drives every “m” sets of the line selection lines in a third drive order and a fourth drive order that are different from an arrangement order of the line selection lines on the liquid-crystal panel,
wherein the operation further including:
(3) driving the line selection lines in the third drive order for “k” flames; and
(4) driving the line selection lines in the fourth drive order for “k” flames.

11. The liquid-crystal display apparatus according to claim 10,
wherein the “n” sets are 4 sets; and
wherein the “m” sets are 8 sets.

12. The liquid-crystal display apparatus according to claim 10,
wherein the first, second, third and fourth drive orders are set so that an averaged level of the gradation data is equal to each other between the pixels corresponding to the “n” sets of the line selection lines.

13. The liquid-crystal display apparatus according to claim 1,
wherein the first and second drive orders are set so that an averaged level of the gradation data is equal to each other between the pixels corresponding to the “n” sets of the line selection lines,
wherein, when the line selection lines are driven in the first and second driven orders, each driven pixel is supplied with the gradation data having a same polarity.

14. The liquid-crystal display apparatus according to claim 1,
wherein the row driver rearranges image data including the gradation data in accordance with the first and second drive order.

15. The liquid-crystal display apparatus according to claim 1, further comprising a control unit that controls the row driver, and
wherein the control unit rearranges image data including the gradation data in accordance with the first and second drive orders.

16. A line driver for driving a plurality of line selection lines arranged in a liquid-crystal display, the line driver comprising:
a shift register sequentially selecting “p” sets of the line selection lines; and
a switching device selecting one from among the “p” sets of the line selection lines to drive every “m” sets of the line selection lines in one of a first drive order and a second drive order that are different from an arrangement order of the line selection lines on the liquid-crystal panel.

17. The line driver according to claim 16,
wherein the first and second driven orders are set so that an averaged level of the gradation data is equal to each other between the pixels corresponding to the “n” sets of the line selection lines.

18. The line driver according to claim 16,
wherein the row driver rearranges image data including the gradation data based on the first and second drive order.

19. A liquid-crystal display apparatus comprising:
a liquid-crystal panel including pixels that are arranged at positions where a plurality of row selection lines and a plurality of line selection lines intersect, the pixels driven by activating thin-film transistors connected to the row selection lines and the line selection lines;
a row driver generating a voltage based on gradation data and applying the voltage to the row selection lines by inverting a polarity of the voltage every “n” sets of the row selection lines; and
a line driver driving every “m” sets of the line selection lines in a first drive order that is different from an arrangement order of the line selection lines on the liquid-crystal panel,
wherein the line driver drives the line selection lines in the first drive order by performing:
(1) driving a first group of the line selection lines that corresponds to the row selection lines that are applied with a first voltage having a same polarity; and
(2) driving a second group of the line selection lines that corresponds to the row selection lines that are applied with a second voltage having polarity opposite to the first voltage,
wherein the line driver varies the first drive order in the each groups every “k” flames.

20. The liquid-crystal display apparatus according to claim 19,
wherein the first drive order is varied so that an averaged level of the gradation data is equal to each other between the pixels corresponding to the “n” sets of the line selection lines.
